(19) United States
(12) Patent Application Publication
(10) Pub. No.: US 2024/0303425 A1
(43) Pub. Date: Sep. 12, 2024

(54) SPREADSHEET APPARATUS, SPREADSHEET METHOD AND NON-TRANSITORY COMPUTER READABLE RECORDING MEDIUM

(71) Applicant: CASIO COMPUTER CO., LTD., Tokyo (JP)

(72) Inventor: Kota SAJI, Tokyo (JP)

(73) Assignee: CASIO COMPUTER CO., LTD., Tokyo (JP)

(21) Appl. No.: 18/429,635

(22) Filed: Feb. 1, 2024

(30) Foreign Application Priority Data
Mar. 10, 2023 (JP) 2023-037621

(51) Int. Cl. G06F 40/18; G06F 40/111

(52) U.S. Cl. CPC G06F 40/18; G06F 40/111

(57) ABSTRACT

A spreadsheet apparatus accepts a calculation formula for executing calculation with a target being a calculation element that is input in a table format, as a first calculation formula of a first format including a first part corresponding to a description format of referring to a cell of a table and a second part corresponding to a description format for mathematical natural display, and executes one of (i) a calculation process for calculating the first calculation formula by using a value of the cell that the first part refers to, and (ii) a display process for displaying on a display the first calculation formula in a display mode of the mathematical natural display indicated by the second part.

### CROSS-REFERENCE TO RELATED APPLICATIONS

This application is based upon and claims the benefit of priority from prior Japanese Patent Application No. 2023-037621, filed Mar. 10, 2023, the entire contents of which are incorporated herein by reference.

### FIELD

The present disclosure relates to a spreadsheet apparatus, a spreadsheet method and a non-transitory computer readable recording medium.

### BACKGROUND

Conventionally, in various kinds of business operations, spreadsheet application software (hereinafter abbreviated as “spreadsheet software”) that is executed by a computer has widely been used.

In addition, in recent years, introduction of ICT (Information and Communication Technology) equipment into school education has been progressing, mainly in Europe and North America, and accordingly there are an increasing number of cases where electronic educational materials are used in classes and regularly scheduled tests in schools (for example, US 2021/0303769 A1). As one of the electronic educational materials, spreadsheet software is used as a matter of course.

In the spreadsheet software, a user can input a calculation formula by using, as calculation elements (calculation parameters), numerical values that are input to cells of a table, and can cause calculation to be executed. In this case, cells in which numerical values that are calculation elements are input are designated by a cell coordinate (range). For example, if a calculation formula is input in which a cell coordinate range is designated as an argument of a function (SUM) of calculating a sum, such as “=SUM (B1:B5)”, a sum can be calculated with targets being numerical values that are input to cells of a cell coordinate (B1) to a cell coordinate (B5).

### SUMMARY

A spreadsheet apparatus according to the present disclosure accepts a calculation formula for executing calculation with a target being a calculation element that is input in a table format, as a first calculation formula of a first format including a first part corresponding to a description format of referring to a cell of a table and a second part corresponding to a description format for mathematical natural display, and executes one of (i) a calculation process for calculating the first calculation formula by using a value of the cell that the first part refers to, and (ii) a display process for displaying on a display the first calculation formula in a display mode of the mathematical natural display indicated by the second part.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate an embodiment of the invention, and together with the general description given above and the detailed description of the embodiment given below, serve to explain the principles of the invention.

FIG. 1 is a diagram illustrating a configuration of an entirety of a spreadsheet system according to an embodiment of a spreadsheet apparatus, a spreadsheet method and a recording medium of the present disclosure.

FIG. 2 is a diagram illustrating an example of a spreadsheet created by spreadsheet software.

FIG. 3 is a diagram illustrating an example of storage content of an input value memory of a terminal that the spreadsheet system includes.

FIG. 4A is a diagram illustrating an example of storage content of a standard table in a cell value memory of the terminal.

FIG. 4B is a diagram illustrating an example of storage content of a decimal table in the cell value memory of the terminal.

FIG. 5 is a diagram illustrating an example of a calculation formula including a spreadsheet software function and mathematical natural display, the calculation formula being input to the spreadsheet.

FIG. 6 is a diagram illustrating an example of storage content of the input value memory of the terminal, this example corresponding to the example of FIG. 5.

FIG. 7 is a flowchart illustrating a spreadsheet process of a processor of the terminal according to the spreadsheet software.

FIG. 8 is a flowchart illustrating an example of a spreadsheet software function conversion process of FIG. 7 in a case of a calculation formula including a spreadsheet software function of a “SUM ( . . . )” format.

FIG. 9A is a diagram illustrating an example of storage content of the standard table in a case where a calculation result is stored.

FIG. 9B is a diagram illustrating an example of storage content of the decimal table in a case where the calculation result is stored.

FIG. 10 is a diagram illustrating an example of the spreadsheet including display of a calculation result.

FIG. 11 is a diagram for describing a concrete example of a calculation formula including a spreadsheet software function and mathematical natural display.

FIG. 12 is a diagram for describing another concrete example of a calculation formula including a spreadsheet software function and mathematical natural display.

FIG. 13 is a diagram for describing still another concrete example of a calculation formula including a spreadsheet software function and mathematical natural display.

### DETAILED DESCRIPTION

Hereinafter, an embodiment of the present disclosure is described with reference to the accompanying drawings.

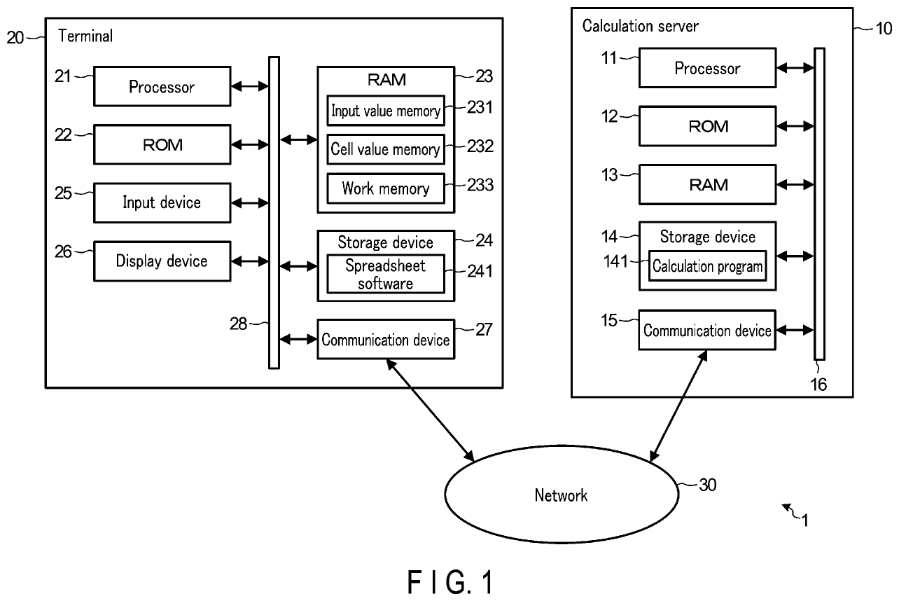

FIG. 1 is a diagram illustrating a configuration of an entirety of a spreadsheet system according to an embodiment of a spreadsheet apparatus, a spreadsheet method and a recording medium of the present disclosure. The spreadsheet system 1 includes a calculation server 10 and a terminal 20. The calculation server 10 and the terminal 20 are communicably connected via a network 30. The network 30 is, for example, the Internet. Note that FIG. 1 illustrates only one terminal 20, but the number of terminals 20 connectable to the calculation server 10 via the network 30 is not limited to one. One or more terminals 20 can be connected.

The spreadsheet system 1 executes calculation based on a calculation formula that a user inputs. Specifically, in the spreadsheet system 1, calculation data based on a calculation formula, which is input to a cell of a spreadsheet displayed on the terminal 20, and a value that is input to a cell that is to be referred to, is transmitted from the terminal 20 to the calculation server 10. The calculation server 10 executes the calculation in accordance with the calculation data, and transmits a calculation result to the terminal 20. The terminal 20 receives the calculation result, and sets the calculation result as a data value of the cell to which the calculation formula is input.

The calculation server 10 includes a processor 11, a ROM 12, a RAM 13, a storage device 14, and a communication device 15. These are interconnected via a system bus 16.

The processor 11 may be an integrated circuit such as a central processing unit (CPU). The ROM 12 records information that is used in the operation of the processor 11. The RAM 13 functions as a main storage device of the processor 11. The storage device 14 may be a nonvolatile memory capable of random write and read, such as a hard disk drive (HDD) or a solid state drive (SSD). The storage device 14 stores a server control program used in the processor 11, various programs such as an arithmetic program for executing various arithmetic operations, parameters, and the like. The programs include a calculation program 141 that causes the calculation server 10 to function as a part of the spreadsheet apparatus according to the embodiment. The processor 11 controls the operation of the calculation server 10 in accordance with the programs stored in the storage device 14. As the processor 11, a processor other than the CPU, for example, an application specific integrated circuit (ASIC) or a field programmable gate array (FPGA), may be used. The communication device 15 can communicate with an external communication network, such as the network 30.

The terminal 20 includes a processor 21, a ROM 22, a RAM 23, a storage device 24, an input device 25, a display device 26, and a communication device 27. These are interconnected via a system bus 28. The terminal 20 may be electronic equipment such as a personal computer (PC), a tablet terminal, a smartphone, or the like.

The processor 21 is an integrated circuit, such as a CPU, which controls various operations of the terminal 20. As the processor 21, some other integrated circuit, such as an ASIC, FPGA or the like, may be used. The ROM 22 records a startup program, and the like. The RAM 23 functions as a main storage device of the processor 21. The storage device 24 may be a nonvolatile memory capable of random write and read, such as an HDD or an SSD. The storage device 24 stores various programs, such as a terminal control program used in the processor 21, parameters, and the like. The processor 21 controls the operation of the terminal 20 by executing various programs in accordance with an input signal from the input device 25, and a reception signal by the communication device 27. The various programs may be downloaded to the storage device 24 from a Web server (not illustrated) via the network 30 and the communication device 27. The communication device 27 can communicate with an external communication network, such as the network 30.

The input device 25 includes external input devices such as a keyboard, a mouse and the like, or an input board displayed on the display device 26 of the terminal 20. By the operation of the input device 25, an input signal is input to the processor 21 from an input interface (I/F) via the system bus 28.

The display device 26 includes an external display device such as a liquid crystal display, or a display unit such as a liquid crystal display of the terminal 20. An output signal is transmitted to the display device 26 from the processor 21 via the system bus 28 and an output interface (I/F).

In the present embodiment, spreadsheet software 241 is installed in the storage device 24. The spreadsheet software 241 is a spreadsheet program that, by being executed by the processor 21, causes the terminal 20 to function as a part of the spreadsheet apparatus according to the embodiment. In the terminal 20, the processor 21 controls operations of the circuitry components according to instructions described in the spreadsheet software 241, and the software and hardware cooperate to implement various functions to be described later in the description of operations. At this time, the processor 21 secures an input value memory 231 and a cell value memory 232 in the RAM 23, and causes a work memory 233 to temporarily store various data that is generated during operations. The input value memory 231 is used to save data that is input to the cells of the spreadsheet by the user, and the cell value memory 232 is used to similarly save data that is input to the cells of the spreadsheet, or to save a calculation result by the calculation server 10.

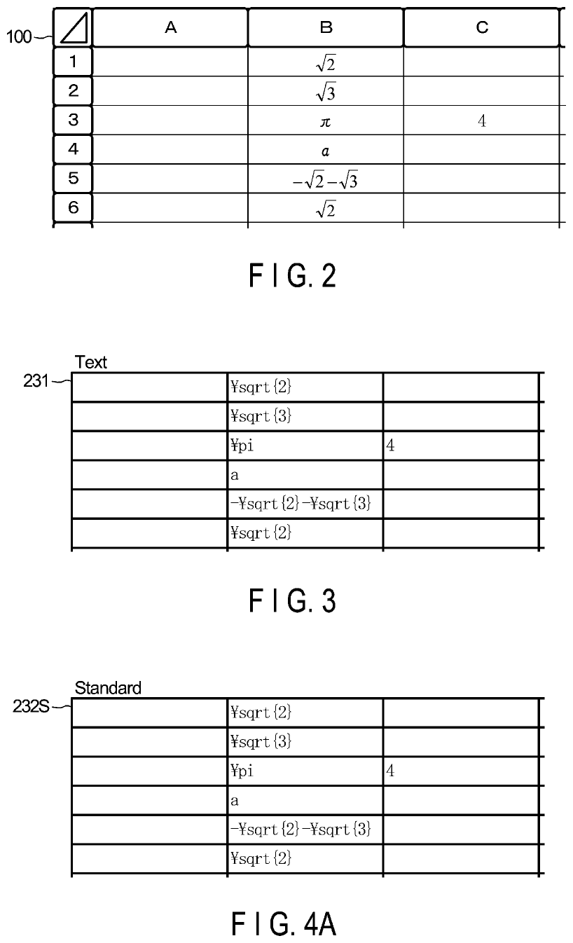

FIG. 2 is a diagram illustrating an example of a spreadsheet 100 created by the spreadsheet software 241 and displayed on the display device 26. In the spreadsheet software 241, a cell value can be displayed in each cell of the spreadsheet 100, for example, by mathematical natural display such as “root 2” in a cell B1.

FIG. 3 is a diagram illustrating an example of storage content of the input value memory 231. This example corresponds to the example of the spreadsheet 100 illustrated in FIG. 2. As illustrated in FIG. 3, in the present embodiment, the content that is input to the cells of the spreadsheet 100 is of two kinds. As regards the input of a numerical value, a variable, and a spreadsheet software function that is a prescribed function specialized for the spreadsheet software 241, this input is accepted as text of input characters as such. On the other hand, an input for mathematical natural display is accepted not as input characters as such, but as text by a LaTex notation method that is a notation method for a typesetting process system. For example, “root 2” is input as text of “¥sqrt {2}” by the LaTex notation method. The input value memory 231 stores the text input to each cell in this manner, as text data by the LaTex notation method (hereinafter referred to as “LaTex data”).

Note that the mathematical natural display (a mathematically natural display mode of a mathematical expression) is a mathematical display (description) mode of a mathematical expression, and is a display (description) mode that is natural for a human and enables easy understanding of a mathematical expression. In the mathematical natural display, numerals and signs are not only arranged horizontally, but also arranged vertically, so that the mathematical meaning of numerals and signs can easily be understood. On the other hand, a display (description) mode, which a computer can interpret as a calculation formula, is, for example, a display (description) mode by the LaTex notation method. In the LaTex notation method, by horizontally arranging numerals and signs, the computer can interpret a mathematical expression while sequentially processing the numerals and signs.

The notation for “mathematical natural display” is sometimes simply expressed as “Math format”, and the “Math format” causes fractions, irrational numbers, and other expressions to be displayed as they are written on paper. For this “Math format”, the notation such as “LaTex notation method” is sometimes expressed as “Linear format”, and the “Linear format” causes fractions and other expressions to be displayed in a single line.

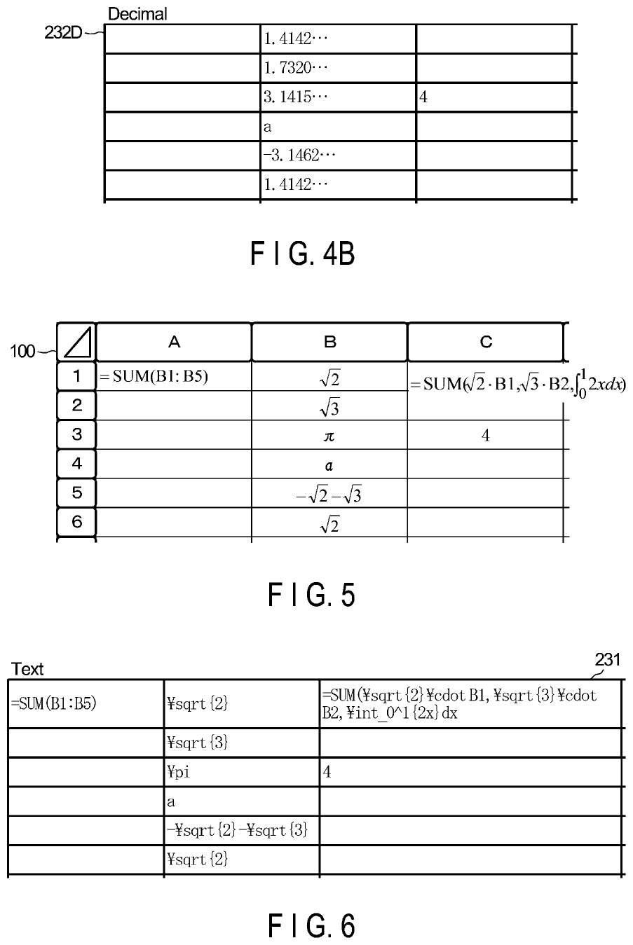

The cell value memory 232 includes a standard table and a decimal table. FIG. 4A is a diagram illustrating an example of storage content of a standard table 232S, and FIG. 4B is a diagram illustrating an example of storage content of a decimal table 232D. The standard table 232S, like the input value memory 231, stores the cell value of each cell of the spreadsheet 100 as LaTex data. The decimal table 232D stores the cell value of each cell of the spreadsheet 100 as numerical value data of a decimal notation method.

The decimal table 232D stores, as a cell value, a calculation element (a numerical value, a calculation formula, or the like) stored in the input value memory 231, or a calculation result of the calculation formula. The spreadsheet 100 displays the cell value of each cell in accordance with the storage content of the standard table 232S. Specifically, the text by the LaTex notation method is typeset by the typesetting process system of LaTex, and is displayed. Thereby, for example, as illustrated as “root 2” in the cell B1 of the spreadsheet 100 of FIG. 2, the cell value can be displayed in each cell by the mathematical natural display. In addition, even if a calculation element stored in the input value memory 231 is a calculation formula, there are a case where the calculation formula is calculated and a case where the calculation formula is not calculated. Whether or not the calculation formula is calculated depends on whether or not a sign “=” is input at the beginning of the calculation formula. Thus, even in the case where a calculation formula, “−¥sqrt{2}−¥sqrt {3}”, in the example of the input value memory 231 illustrated in FIG. 3 is input by the LaTex notation method, if “=” is not input, the calculation formula is not calculated, and the calculation formula is stored as the cell value in the standard table 232S. Thus, as illustrated in a cell B5 of FIG. 2, the calculation formula is displayed as the cell value by the mathematical natural display.

On the other hand, regardless of the presence or absence of “=” at the beginning of the calculation formula, the decimal table 232D stores a calculation result obtained by calculating the cell value of each cell of the spreadsheet 100 as numerical data of the decimal notation method. For example, “root 2” is stored as “1.14142 . . . ”, and “−root 2−root 3” is stored as “−3.1462 . . . ”.

Next, an operation of the spreadsheet system 1 of the embodiment is described.

FIG. 5 is a diagram illustrating an example of calculation formula including a spreadsheet software function and mathematical natural display, the calculation formula being input to the spreadsheet 100, and FIG. 6 is a diagram illustrating an example of storage content of the input value memory 231, this example corresponding to the example of FIG. 5. In this example, calculation formulae including a spreadsheet software function and mathematical natural display are input to a cell A1 and a cell C1. Note that in the present embodiment, a calculation formula including mathematical natural display is not limited to a case where the calculation formula is described by the mathematical natural display, but includes a case where even if the calculation formula is not described by the mathematical natural display, the cell value of a cell to be referred to is the mathematical natural display.

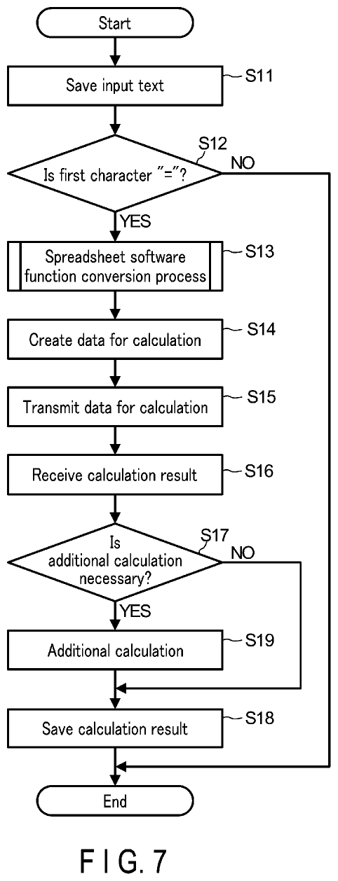

FIG. 7 is a flowchart illustrating a spreadsheet process of the processor 21 according to the spreadsheet software 241.

If text is input to a freely chosen cell from the input device 25, the processor 21 stores the text data (LaTex data) in the input value memory 231 (step S11). Note that the input by the input device 25 can be, for example, a text input by the LaTex notation method by a keyboard. In addition, since there is a case where a user is not familiar with the LaTex notation method, candidates of a function by the LaTex notation method may be presented during the input and the user may be prompted to select the candidates. Alternatively, a software keyboard, which enables selection of a function by the LaTex notation method, may be displayed, and the selection may be made by pressing a button on the software keyboard. In addition, a description example may be automatically input by a suggest function, including a description method of arguments of a function by the LaTex notation method. Besides, a calculation formula of a mathematical natural display mode, which is input by handwriting, may be recognized by image processing or the like, and may be converted to the LaTex notation method.

Then, the processor 21 determines whether or not a first character of the LaTex data stored in the input value memory 231 is “=” (step S12). If the processor 21 determines that the first character is not “=” (step S12 (NO)), this means that the input text is not a calculation formula that is to be calculated immediately, and thus the processor 21 terminates the process illustrated in this flowchart. In the case where the process illustrated in the flowchart was terminated in this manner, the processor 21 saves the cell values in the standard table 232S and decimal table 232D of the cell value memory 232, based on the text data saved in the input value memory 231. Thus, as described above, in the case where the first character is not “=”, even if the input text is a calculation formula, the calculation formula is not calculated, and the input text is typeset by the typesetting process system of LaTex and is displayed in the cell of the spreadsheet 100.

If the processor 21 determines that the first character is “=” (step S12 (YES)), the processor 21 executes a spreadsheet software function conversion process, and converts a spreadsheet software function included in the input calculation formula into the LaTex notation method (step S13). In the spreadsheet software function conversion process, the calculation formula is successively converted from the beginning part into the LaTex notation method. At this time, whether or not to be a spreadsheet software function is determined by forward match. It is assumed that there is no overlap between a spreadsheet software function name and another function name. Alternatively, in the case of using a spreadsheet software function, such a rule may be provided that a predetermined sign, such as “#”, is added at the beginning. In the case where the spreadsheet software function is determined, a process is applied to each argument within ( ). The content of the spreadsheet software function conversion process varies depending on the kind of spreadsheet software function.

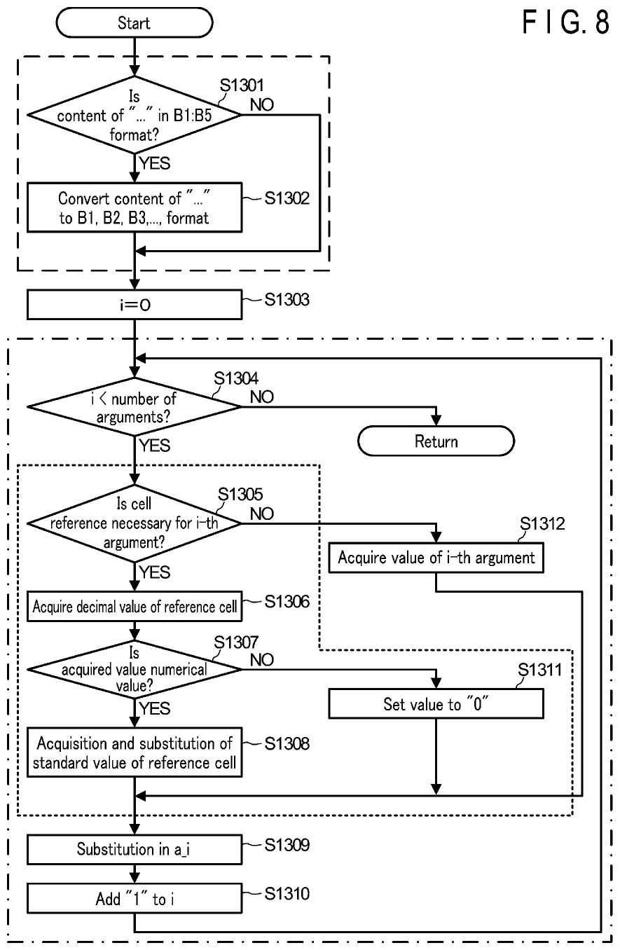

FIG. 8 is a flowchart illustrating an example of the spreadsheet software function conversion process in a case of a calculation formula including a spreadsheet software function of a “SUM ( . . . )” format, such as “=SUM (B1:B5)” illustrated in FIG. 5 and FIG. 6. The spreadsheet software function conversion process in this case includes, as a pre-process, an R1C1 process that changes each part of an R1C1 reference format of input content to an A1 reference format, and includes a spreadsheet function process that is an actual process part. In FIG. 8, a process surrounded by a broken line is the R1C1 process, and a process surrounded by a dot-and-dash line is the spreadsheet function process. The spreadsheet function process includes a cell value reference process surrounded by a dotted line. The cell value reference process is a process of acquiring a decimal value and a standard value in regard to each of input contents B1, B2, . . . . Only in a special function (SUM, COUNT, etc.), after determining whether a decimal value is a numerical value or not, a value to be substituted is determined. Except for the special function, a standard value is substituted.

Specifically, the processor 21 determines whether the content of “ . . . ” in the calculation formula including the spreadsheet software function of the “SUM ( . . . )” format is a “B1:B5” format (a format designating a plurality of cells by a cell coordinate range) (step S1301). If the processor 21 determines that the content of “ . . . ” is not the “B1:B5” format (step S1301 (NO)), the processor 21 goes to a process of step S1303 to be described later.

If the “B1:B5” format is determined (step S1301 (YES)), the processor 21 converts the content of “ . . . ” to a “B1, B2, B3, B4, B5” format (a format in which a plurality of cells are designated by individual cell coordinates) (step S1302). The processor 21 causes the work memory 233 to temporarily store the calculation formula of the converted result.

Then, the processor 21 sets “0” to a pointer i (not illustrated) provided in the work memory 233 (step S1303).

Thereafter, the processor 21 determines whether the value set for the pointer i is less than the number of arguments in the calculation formula temporarily stored in the work memory 233 (step S1304).

If the processor 21 determines that the value set for the pointer i is less than the number of arguments (step S1304 (YES)), the processor 21 determines whether an i-th argument indicated by the value of the pointer i requires cell reference (step S1305).

Here, if it is determined that the cell reference is necessary (step S1305 (YES)), the processor 21 acquires the decimal value of the cell to be referred to from the decimal table 232D of the cell value memory 232 (step S1306). The processor 21 causes the work memory 233 to temporarily store the acquired decimal value.

Thereafter, the processor 21 determines whether the decimal value is a numerical value or not (step S1307).

If the processor 21 determines that the decimal value is a numerical value (step S1307 (YES)), the processor 21 acquires the standard value of the cell to be referred to from the standard table 232S of the cell value memory 232, and substitutes the acquired standard value for the decimal value that is temporarily stored in the work memory 233 (step S1308).

Then, the processor 21 substitutes the decimal value temporarily stored in the work memory 233, for a value of a_i in the converted calculation formula, which is to be temporarily stored in the work memory 233 (step S1309).

Thereafter, the processor 21 adds “1” to the pointer i (step S1310). Then, the processor 21 goes to the process of the above-described step S1304.

In addition, in the above-described step S1307, for example, since the decimal value of the reference destination cell B4 is a variable “a”, it is determined that the acquired value is not a numerical value. In this manner, if it is determined that the acquired value is not a numerical value (step S1307 (NO)), the processor 21 substitutes “0” for the decimal value temporarily stored in the work memory 233 (step S1311). Then, the processor 21 advances to the process of the above-described step S1309.

In addition, in the above step S1305, if it is determined that the cell reference is not necessary (step S1305 (NO)), the processor 21 acquires the value of an i-th argument indicated by the value of the pointer i (step S1312). Then, the processor 21 goes to the process of the above step S1309, and substitutes the acquired value of the i-th argument for the value of a_i in the calculation formula.

The process of the above step S1304 to step S1312 is repeated, and if it is determined in step S1304 that the value set in the pointer i is less than the number of arguments in the calculation formula (step S1304 (NO)), the processor 21 returns to the routine of the upper level.

By the above-described spreadsheet software function conversion process in the case of the calculation formula of “=SUM (B1:B5)”, the work memory 233 stores LaTex data indicating, as the converted calculation formula,

$$\begin{matrix}( Math . 1 ) & \\ = {\sum }_{j = 0}^{i} {a}_{j} & \end{matrix}$$

the LaTex data being

$$\begin{matrix}( Math . 2 ) & \\ = SUM ( j = 0 ) \hat{} ( i ) \{ a \backslash ( j ) \} & \end{matrix}$$

i.e.,

$$\begin{matrix}( Math . 3 ) & \\ = ( \backslash sqrt \{ 2 \} + \backslash sqrt \{ 3 \} + ( \backslash pi ) + ( 0 ) + ( - \backslash sqrt \{ 2 \} - \backslash sqrt \{ 3 \} ) & \end{matrix}$$

Note that the sign “backslash” in the LaTex data is a variant notation having the same meaning as “¥”.

In addition, in the case of the following that is input to the cell C1 in the spreadsheet 100 of FIG. 5,

$$\begin{matrix}( Math . 4 ) & \\ = SUM ( \sqrt{2} \cdot B 1 , \sqrt{3} \cdot B 2 , {\int }_{0}^{1} 2 xdx ) & \end{matrix}$$

by the spreadsheet software function conversion process, in the work memory 233, as the converted calculation formula,

$$\begin{matrix}( Math . 5 ) & \\ = SUM ( \backslash sqrt \{ 2 \} \backslash cdot \backslash sqrt \{ 2 \} , \backslash sqrt \{ 3 \} \backslash cdot \backslash sqrt \{ 3 \} , int\_ 0 \hat{} 1 \{ 2 x \} dx ) & \end{matrix}$$

is stored.

Hereinafter, some examples are described. Here, LaTex data stored in the input value memory 231, display on the spreadsheet 100, and a converted calculation formula, are described successively.

$$\begin{matrix}( Math . 6 ) & \\ \begin{matrix}= ¥sum\_ \{ x = 0 \} \hat{} \{ 10 \} x \hat{} \{ B 5 \} \\ = {\sum }_{x = 0}^{10} {x}^{B 5} \\ = \backslash sum\_ \{ x = 0 \} \hat{} \{ 10 \} x \hat{} \{ \backslash sqrt \{ 2 \} - \backslash sqrt \{ 3 \} \}\end{matrix} & ( 1 )\end{matrix}$$

$$\begin{matrix}= ¥sum\_ \{ x = B 1 \} \hat{} \{ B 5 \} x \hat{} \{ 2 \} \\ = {\sum }_{x = B 1}^{B 5} {x}^{2} \\ = \backslash sum\_ \{ x = \backslash sqrt \{ 2 \} \} \hat{} \{ - \backslash sqrt \{ 2 \} - \backslash sqrt \{ 3 \} \} x \hat{} \{ 2 \}\end{matrix} \qquad ( 2 )$$

$$\begin{matrix}= ¥ sqrt \{ ¥ frac \{ SUM ( B 3 : B 7 ) \} \{ C3 \} \} \\ = \sqrt{\frac{SUM ( B 3 : B 7 )}{C 3}} \\ = \backslash sqrt \{ frac \{ sum\_ \{ \backslash pi , a , \{ - \backslash sqrt \{ 2 \} - \backslash sqrt \{ 3 \} , \backslash sqrt \{ 2 \} , ( … ) \} \{ 4 \} \}\end{matrix} \qquad ( 3 )$$

$$\begin{matrix}= SUM \{ ¥ frac \{ B 3 \} \{ 3 \} : ¥ frac \{ B 7 \} \{ 5 \} \} \\ = SUM ( \frac{B 3}{3} : \frac{B 7}{5} ) \\ = SUM ( \backslash frac \{ \backslash pi \} \{ 3 \} : frac ( … ) \{ 5 \} ⇒ Syntax Error\end{matrix} \qquad ( 4 )$$

Here, in equation (4), since denominators are unclear in regard to cells B4 to B6, a syntax error occurs.

Still other examples are described.

$$\begin{matrix}( Math . 7 ) & \\ \begin{matrix}= ¥ int\_ \{ B 3 \} \hat{} \{ B 7 \} ¥ sqrt \{ ¥ frac \{ x \} \{ C 3 \} \} dx \\ = {\int }_{B 3}^{B 7} \sqrt{\frac{x}{C 3}} dx \\ = \backslash int\_ \{ \backslash pi \} \hat{} ( … ) \backslash sqrt \{ frac \{ x \} \{ 4 \} dx\end{matrix} & ( 5 )\end{matrix}$$

$$\begin{matrix}= ¥ int\_ \{ B 1 \} \hat{} \{ SUM ( B 1 : B 5 ) \} ¥ frac \{ B 7 \} \{ ¥ sqrt \{ x \} \} dx \\ = {\int }_{B 1}^{SUM ( B 1 : B 5 )} \frac{B 7}{\sqrt{x}} dx \\ = \backslash int\_ \{ \backslash sqrt \{ 2 \} \hat{} \{ \backslash sum\_ \{ \backslash sqrt \{ 2 \} , \backslash sqrt \{ 3 \} , \backslash pi , a , - \backslash sqrt \{ 2 \} - \backslash sqrt \{ 3 \} \} \} \backslash frac ( … ) \{ \backslash sqrt \{ x \} \} dx\end{matrix} \qquad ( 6 )$$

$$\begin{matrix}= OFFSET ( C 2 , ¥ sin \{ A 3 \} , ¥ int\_ \{ 1 \} \hat{} \{ B 3 \} ¥ frac \{ x \} \{ B 1 \} dx ) \\ = OFFSET ( C 2 , sin A 3 , {\int }_{1}^{B 3} \frac{x}{B 1} dx ) \\ = \backslash OFFSET ( C 2 , \backslash sin \{ … \} , \backslash int\_ \{ 1 \} \hat{} \{ \backslash pi \} \backslash frac \{ x \} \{ \backslash sqrt \{ 2 \} \} dx\end{matrix} \qquad ( 7 )$$

Here, the spreadsheet software function “OFFSET” of equation (7) executes cell reference that is unique to this function. Specifically, the first argument remains as such, and the other arguments refer to cell values. In the example of the spreadsheet 100 of FIG. 5, since a cell value is not set for the cell C1, this calculation formula, too, becomes a syntax error.

The description returns to FIG. 7. Using the numerical value data saved in the cell to be referred to, the processor 21 calculates the calculation formula that is converted to the LaTex notation method by the above-described spreadsheet software function conversion process, thereby creating data for calculation that can be calculated by the calculation server 10 (step S14). The processor 21 causes the work memory 233 to temporarily store the created data for calculation. For example, in the case of the calculation formula of the cell A1 in the spreadsheet 100 of FIG. 5, the data for calculation is as follows.

$$\begin{matrix}( Math . 8 ) & \\ ( ( 2 ) \hat{} ( 1 / 2 ) + ( 3 ) \hat{} ( 1 / 2 ) + ( \backslash pi ) + ( 0 ) + ( - ( 2 ) \hat{} ( 1 / 2 ) - ( 3 ) \hat{} ( 1 / 2 ) ) & \end{matrix}$$

In addition, in the case of the calculation formula of the cell C1 in the spreadsheet 100 of FIG. 5, the data for calculation is as follows.

$$\begin{matrix}( Math . 9 ) & \\ ( ( 2 ) \hat{} ( 1 / 2 ) * ( 2 ) \hat{} ( 1 / 2 ) + ( 3 ) \hat{} ( 1 \text{/2} ) * ( 3 ) \hat{} ( 1 / 2 ) + integral \{ ( 0 ) \hat{} ( 1 ) , 2 x , x \} ) & \end{matrix}$$

In this manner, the processor 21 converts the calculation formula and the mathematical natural display, including the spreadsheet software function accepted from the user by the input device 25, into a second calculation formula that can be calculated by the calculation server 10.

The processor 21 transmits the data for calculation, which indicates the converted second calculation formula, to the calculation server 10 by the communication device 27 via the network 30 (step S15).

Although not illustrated in the flowchart in particular, if the processor 11 of the calculation server 10, which operates according to the calculation program 141 stored in the storage device 14, receives the data for calculation by the communication device 15, the processor 11 temporarily stores the data for calculation in the RAM 13. Then, the processor 11 executes the calculation of the calculation formula indicated by the data for calculation temporarily stored in the RAM 13, and returns the calculation result to the terminal 20 by the communication device 15 via the network 30.

The processor 21 of the terminal 20 receives, by the communication device 27, the calculation result that is returned from the calculation server 10 via the network 30 (step S16). The calculation result includes the standard value and the decimal value. For example, in the case of the calculation formula of the cell A1 in the spreadsheet 100 of FIG. 5, the standard value is “¥pi”, and the decimal value is “3.1415 . . . ”. In addition, in the case of the calculation formula of the cell C1 in the spreadsheet 100 of FIG. 5, both the standard value and the decimal value are “6”. The processor 21 causes the work memory 233 to temporarily store the received calculation result.

Thereafter, the processor 21 determines whether additional calculation is necessary or not (step S17). For example, the spreadsheet software functions include functions that cannot be processed by the calculation server 10, such as “COUNT” and “OFFSET”. Thus, the processor 21 determines here whether the LaTex data stored in the input value memory 231 include such functions.

If it is determined that additional calculation is not necessary (step S17 (NO)), the processor 21 saves the calculation result temporarily stored in the work memory 233, as cell values in the standard table 232S and decimal table 232D of the cell value memory 232 (step S18). Then, the processor 21 terminates the process illustrated in the flowchart. Note that at the time of finishing this process, it is desirable to delete the data temporarily stored in the work memory 233.

On the other hand, if it is determined that additional calculation is necessary (step S17 (YES)), the processor 21 executes additional calculation (step S19). Specifically, the processor 21 executes the calculation of the function included in the calculation formula stored in the input value memory 231, with respect to the calculation result temporarily stored in the work memory 233. Thereafter, the processor 21 advances to the above-described step S18, and saves the result of the additional calculation as cell values in the standard table 232S and decimal table 232D of the cell value memory 232.

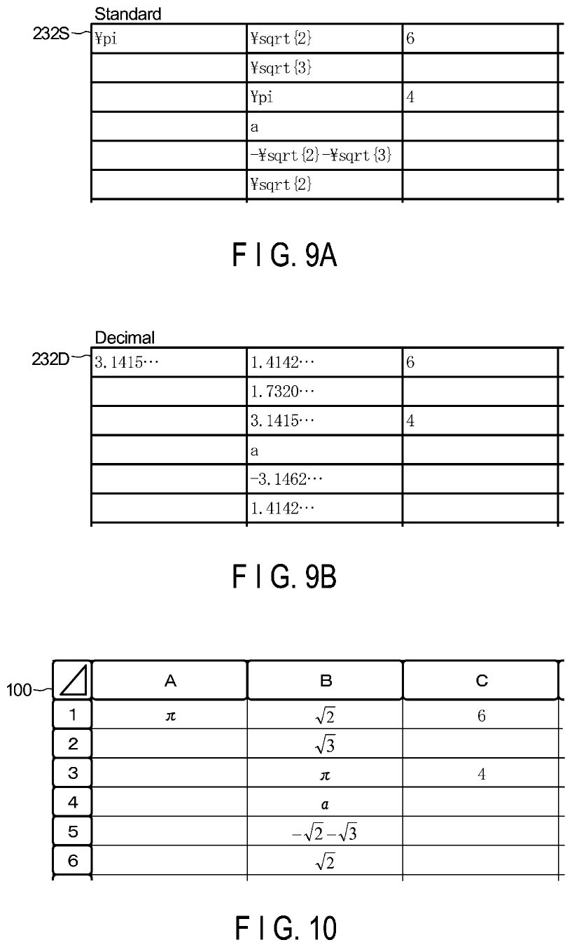

FIG. 9A is a diagram illustrating an example of storage content of the standard table 232S in a case where a calculation result is stored, and FIG. 9B is a diagram similarly illustrating an example of storage content of the decimal table 232D. In addition, FIG. 10 is a diagram illustrating an example of the spreadsheet 100 including display of the calculation result. As illustrated in these Figures, as a calculation result in regard to the calculation formula input to the cell A1 of FIG. 5, “¥pi” is stored in the standard table 232S, “3.1415 . . . ” is stored in the decimal table 232D, and “π” is displayed in the spreadsheet 100. In addition, in regard to the calculation formula input to the cell C1 of FIG. 5, as a calculation result, “6” is stored in both the standard table 232S and the decimal table 232D, and also “6” is displayed in the spreadsheet 100.

### (Concrete Examples)

Hereinafter, in regard to some calculation formulae including spreadsheet software functions and mathematical natural display, concrete examples of processing results in each step are described.

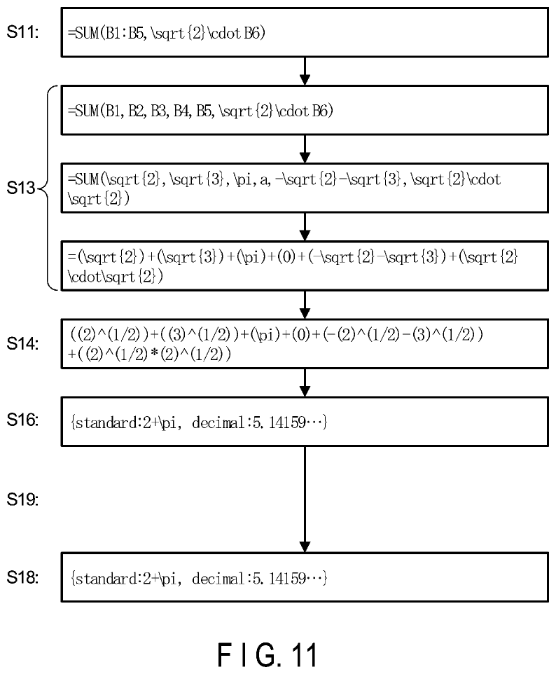

FIG. 11 is a diagram for describing a concrete example of a calculation formula including a spreadsheet software function and mathematical natural display. The calculation formula including a spreadsheet software function and mathematical natural display in this example is

$$\begin{matrix}( Math . 10 ) & \\ = SUM ( B 1 : B 5 , \sqrt{2} \cdot B 6 ) & \end{matrix}$$

In this case, in step S11, the input value memory 231 stores

$$= SUM ( B 1 , B 2 , B 3 , B 4 , B 5 , ∖ sqrt \{ 2 \} ∖ cdot B 6 ) \qquad ( Math . 11 )$$

which is LaTex data. In addition, by the spreadsheet software function conversion process of step S13, conversion is executed to

$$= ( \backslash sqrt \{ 2 \} ) + ( \backslash sqrt \{ 3 \} ) + ( \backslash pi ) + ( 0 ) + ( - \backslash sqrt \{ 2 \} - \backslash sqrt \{ 3 \} ) + ( \backslash sqrt \{ 2 \} ) \backslash cdot \backslash sqrt \{ 2 \} \qquad ( Math . 12 )$$

and, in step S14, as a calculation formula of the LaTex notation method like

$$( ( 2 ) \hat{} ( 1 / 2 ) ) + ( ( 3 ) \hat{} ( 1 / 2 ) ) + ( \backslash pi ) + ( 0 ) + ( - ( 2 ) \hat{} ( 1 / 2 ) - ( 3 ) \hat{} ( 1 / 2 ) ) + ( ( 2 ) \hat{} ( 1 / 2 ) * ( 2 ) \hat{} ( 1 / 2 ) ) \qquad ( Math . 13 )$$

data for calculation that can be calculated by the calculation server 10 is created.

In addition, by transmitting the data for calculation to the calculation server 10, in step S16, as a calculation result from the calculation server 10,

$$\{ standard : 2 + \backslash pi , decimal : 5.14159 … \} \qquad ( Math . 14 )$$

is received. In this case, since additional calculation is not necessary, in step S18, the calculation result is saved in the standard table 232S and decimal table 232D of the cell value memory 232.

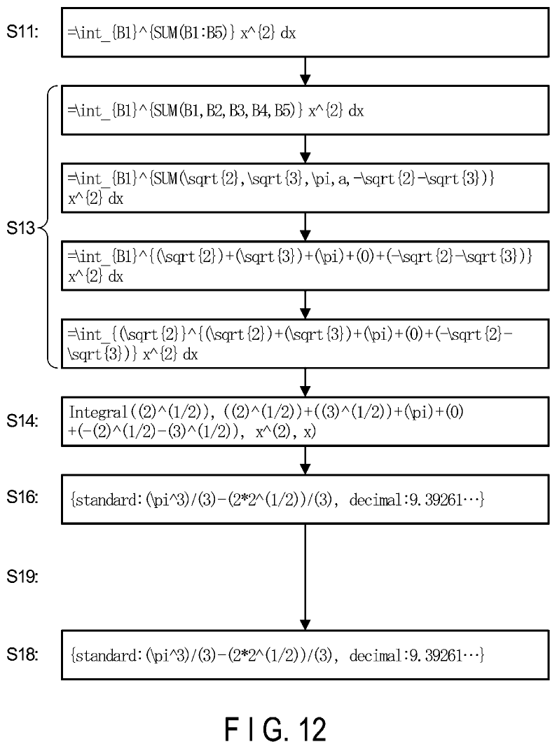

FIG. 12 is a diagram for describing another concrete example of a calculation formula including a spreadsheet software function and mathematical natural display. The calculation formula including a spreadsheet software function and mathematical natural display in this example is

$$= {\int }_{B 1}^{SUM ( B 1 : B 5 )} {x}^{2} dx \qquad ( Math . 15 )$$

In this case, in step S11, the input value memory 231 stores

$$= \backslash int\_ \{ B 1 \} \hat{} \{ SUM ( B 1 : B 5 ) \} x \hat{} \{ 2 \} dx \qquad ( Math . 16 )$$

which is LaTex data. In addition, by the spreadsheet software function conversion process of step S13, conversion is executed to

$$= \backslash int\_ \{ ( \backslash sqrt \{ 2 \} \} \hat{} \{ ( \backslash sqrt \{ 2 \} ) + ( \backslash sqrt \{ 3 \} ) + ( \backslash pi ) + ( 0 ) + ( - \backslash sqrt \{ 2 \} - \backslash sqrt \{ 3 \} ) \} x \hat{} \{ 2 \} dx \qquad ( Math . 17 )$$

and, in step S14, as a calculation formula of the LaTex notation method like

$$Integral ( ( 2 ) \hat{} ( 1 / 2 ) ) , ( ( 2 ) \hat{} ( 1 / 2 ) ) + ( ( 3 ) \hat{} ( 1 / 2 ) ) + ( \backslash pi ) + ( 0 ) + ( - ( 2 ) \hat{} ( 1 / 2 ) - ( 3 ) \hat{} ( 1 / 2 ) ) , x \hat{} ( 2 ) , x \qquad ( Math . 18 )$$

data for calculation that can be calculated by the calculation server 10 is created.

In addition, by transmitting the data for calculation to the calculation server 10, in step S16, as a calculation result from the calculation server 10,

$$\{ standard : ( \backslash pi \hat{} 3 ) / ( 3 ) - ( 2 * 2 \hat{} ( 1 / 2 ) ) / ( 3 ) , decimal : 9.39261 … \} \qquad ( Math . 19 )$$

is received. In this case, since additional calculation is not necessary, in step S18, the calculation result is saved in the standard table 232S and decimal table 232D of the cell value memory 232.

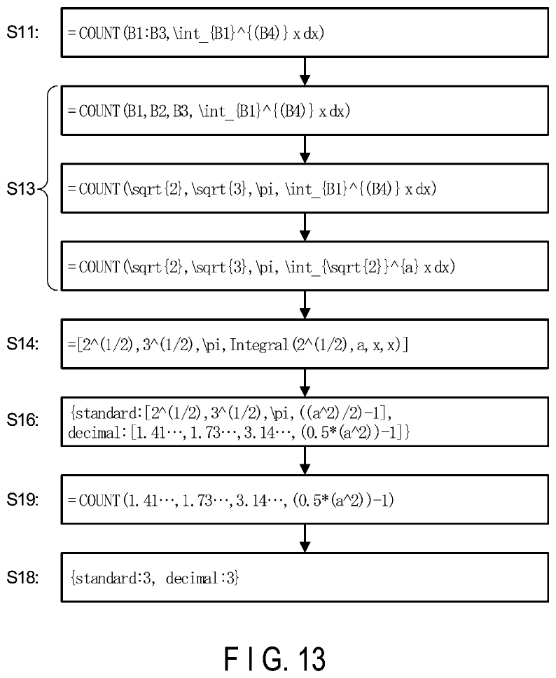

FIG. 13 is a diagram for describing still another concrete example of a calculation formula including a spreadsheet software function and mathematical natural display. The calculation formula including a spreadsheet software function and mathematical natural display in this example is

$$= COUNT ( B 1 : B 3 , {\int }_{B 1}^{B 4} xdx ) \qquad ( Math . 20 )$$

In this case, in step S11, the input value memory 231 stores

$$= COUNT ( B 1 : B 3 , \backslash int\_ \{ B 1 \} \hat{} \{ ( B 4 ) \} \times dx ) \qquad ( Math . 21 )$$

which is LaTex data. In addition, by the spreadsheet software function conversion process of step S13, conversion is executed to

$$= COUNT ( \backslash sqrt \{ 2 \} , \backslash sqrt \{ 3 \} , \backslash pi , \backslash int\_ \{ \backslash sqrt \{ 2 \} \} \hat{} \{ a \} \times dx ) \qquad ( Math . 22 )$$

and, in step S14, as a calculation formula of the LaTex notation method like

$$= [ 2 \hat{} ( 1 / 2 ) , 3 \hat{} ( 1 / 2 ) , \backslash pi , Integral ( 2 \hat{} ( 1 / 2 ) , a , x , x ) ] \qquad ( Math . 23 )$$

data for calculation that can be calculated by the calculation server 10 is created.

In addition, by transmitting the data for calculation to the calculation server 10, in step S16, as a calculation result from the calculation server 10,

$$\{ standard : [ 2 \hat{} ( 1 / 2 ) , 3 \hat{} ( 1 / 2 ) , \backslash pi , ( ( a \hat{} 2 ) / 2 ) - 1 ] , decimal : [ 1.41 … , 1.73 … , 3.14 … , ( 0.5 * ( a \hat{} 2 ) ) - 1 ] \} \qquad ( Math . 24 )$$

is received. In this case, since the calculation formula stored in the input value memory 231 includes a “COUNT” function, additional calculation is necessary. Thus, in step S19, for the decimal value of the calculation result from the calculation server 10, additional calculation, which is

$$= COUNT ( 1.41 … , 1.73 … , 3.14 … , ( 0.5 * ( a \hat{} 2 ) ) - 1 ) \qquad ( Math . 25 )$$

is executed. In addition, in step S18, the calculation result, which is

$$\{ standard : 3 , decimal : 3 \} \qquad ( Math . 26 )$$

is saved in both the standard table 232S and the decimal table 232D of the cell value memory 232.

As described above, if the spreadsheet software function is the SUM function (=SUM ( . . . )), it is determined whether the acquired value from the cell is a value or not, and thereafter the cell value (standard value) is acquired and substituted in the function (SUM ({ . . . , . . . })) that can be processed by the calculation server 10. Then, since the SUM function is calculated by the calculation server 10, the additional calculation for executing the spreadsheet software function is not executed.

In addition, in the case where the spreadsheet software function is the COUNT function, it is determined whether the acquired value from the cell is a value or not, and thereafter the cell value (standard value) is acquired and the argument is delivered to the calculation server 10. Then, after the calculation of the calculation server 10, the COUNT function is executed as the additional calculation.

Although concrete examples are not described, if the spreadsheet software function is the OFFSET function, the first argument remains as such, and, as regards other arguments, after it is determined whether the acquired value from the cell is a value or not, the cell value (standard value) is acquired. Then, the arguments other than the first argument are delivered to the calculation server 10, and after the calculation in the calculation server 10, the COUNT function is executed as the additional calculation.

As described above in detail, according to the spreadsheet system 1 (spreadsheet apparatus) of the embodiment, in the terminal 20, for example, as illustrated in the cell C1 of FIG. 5, the calculation formula for executing calculation with targets being the calculation elements (a numerical value, a calculation formula, etc.), which are input in a table format, is accepted as the first calculation formula of the first format including the first part corresponding to the description format of referring to the cells of the table and the second part corresponding to the description format for the mathematical natural display, and the calculation process for calculating the first calculation formula by using the value of the cell that the first part refers to, or the display process for displaying the first calculation formula in the display mode of the mathematical natural display indicated by the second part, is executed. Accordingly, the spreadsheet system 1 accepts the calculation formula in the case of executing calculation with targets being the calculation elements that are input in the table format, as the calculation formula including the mathematical natural display, and can execute the calculation of the calculation formula, or can display the calculation formula in the display mode including the mathematical natural display. Therefore, the user can input the calculation formula in a flexible description format.

Additionally, the terminal 20 determines whether each calculation element included in the first calculation formula is the first part or the second part, and, as regards the first part, converts the first calculation formula of the first format to the second calculation formula of the second format that does not refer to the cells of the table, by taking in the value of the cell which the first part refers to. By doing so, the spreadsheet system 1 can obtain the calculation result of the first calculation formula if the second calculation formula is calculated, even without executing calculation while referring to the cells of the table. In other words, the spreadsheet system 1 can execute calculation even without referring to the table.

Additionally, in the spreadsheet system 1 of the embodiment, calculation of a designated calculation formula can be executed by a calculation processing unit, for example, the calculation server 10, which can calculate a calculation formula of a third format that includes neither the first part nor the second part. For example, in step S14, the terminal 20 converts the second calculation formula of the second format to a third calculation formula of the third format, and causes the calculation processing unit to calculate the third calculation formula of the third format. Thus, the spreadsheet system 1 can quickly execute calculations by using the calculation processing unit that can quickly execute many calculation processes.

Note that the first calculation formula is a calculation formula that is input to a cell of the table. In accordance with the description format of the first calculation formula in the cell, the terminal 20 determines whether to execute the calculation process for the first calculation formula or to execute the display process for the first calculation formula. The terminal 20 can execute this determination, for example, based on whether the first calculation formula begins with “=”. In this manner, by choosing the description format of the first calculation formula, the user can make a choice as to whether the calculation formula is to be calculated or displayed.

For example, in the first calculation formula of the cell C1 of FIG. 5, the first part includes a description of the spreadsheet software function for spreadsheet calculation, such as the SUM function, for executing calculation that refers to the cell of the table, and a description of a cell coordinate, such as B1, for designating the cell of the table to be referred to. In addition, the second part includes a description of a function for mathematical natural display, such as an integration sign, which does not refer to the cell of the table, and a description of a parameter, such as 2x, which is not a cell coordinate and is a calculation target of the function for the mathematical natural display. In this manner, the user can describe the first calculation formula by the spreadsheet software function, the cell coordinate, the function for mathematical natural display, and the parameter thereof.

Note that the first calculation formula, which the spreadsheet system 1 accepts, is a calculation formula that is input to the cells of the spreadsheet 100, for example, as illustrated in the cell A1 or C1 of FIG. 5. In this calculation formula, the input of the first part is accepted as text of input characters as such, and the input of the second part is accepted as text by the notation method for the typesetting process system. Accordingly, the user that inputs the calculation formula can easily input the calculation formula by using a notation method for a generally used typesetting process system.

Note that the LaTex notation method, for example, is used as the notation method for the typesetting process system. Thus, by adopting the widely used LaTex notation method, the user can easily input the calculation formula.

In addition, in the spreadsheet system 1 of the embodiment, as calculation elements that are input in the table format, numerical data that is a numerical value or a variable, for example, as illustrated in the cell B4 or C3 of FIG. 2, is accepted, and, in addition, LaTex data in which numerical values are expressed by the LaTex notation method, for example, as illustrated in the cell B1 or B3 of FIG. 2, is also accepted. Thus, the spreadsheet system 1 can also accept numerical values, other than calculation formulae, by mathematical natural display.

Note that the spreadsheet system 1 also displays the numerical values input to the cells of the spreadsheet 100 by mathematical natural display on the display device 26. Thus, the user can easily determine whether the numerical values input by the LaTex notation method have correctly been input.

As the cell values of the cells of the spreadsheet 100, the terminal 20 saves the input LaTex data in the standard table 232S in the cell value memory 232 of the RAM 23, and saves numerical value data, in which the input LaTex data is converted to numerical values, in the decimal table 232D in the cell value memory 232. In this manner, the terminal 20 can save, as the cell values of the cells, two kinds of values, namely the standard values and the decimal values.

Note that in the spreadsheet system 1 of the embodiment, the first part included in the first calculation formula includes the spreadsheet software function. In the conversion of the first calculation formula to the second calculation formula, based on the content of the spreadsheet software function, the input content is replaced with the LaTex data by the LaTex notation method. In addition, by using the LaTex data saved in the cell that is referred to, the first calculation formula of the first format is replaced with, for example, the second calculation formula of the LaTex notation method that is the second format that can be calculated by the calculation server 10. At this time, the spreadsheet system 1 changes the processing method in accordance with the content of the spreadsheet software function included in the first calculation formula. For example, in the case of the spreadsheet software function that executes calculation by using the decimal value of the reference cell, such as the SUM function or COUNT function, the terminal 20 executes steps S1307 and S1311 of FIG. 8. In the case of other spreadsheet software functions in which arguments may be left as standard values as such, the terminal 20 does not execute steps S1307 and S1311 of FIG. 8. In this manner, the terminal 20 can convert the first calculation formula to the second calculation formula in accordance with the content of the spreadsheet software function. Note that in the case of a spreadsheet software function such as COUNT function or OFFSET function, which cannot be converted to the format that can be calculated by the calculation server 10, the terminal 20 can execute calculation in a post-process, as in step S19 of FIG. 7.

As the cell value for the cell of the spreadsheet 100 in which the first calculation formula was accepted, the terminal 20 saves LaTex data that is the calculation result of the third calculation formula in the standard table 232S in the cell value memory 232 of the RAM 23, for example, as illustrated in FIG. 9A, and saves numerical value data that is the calculation result of the third calculation formula in the decimal table 232D, for example, as illustrated in FIG. 9B. In this manner, the terminal 20 can save two kinds of values, namely the standard value and the decimal value, as the cell values of the cells.

In addition, for example, as illustrated in the cell A1 of FIG. 10, the terminal 20 displays, by mathematical natural display, the LaTex data that is the calculation result of the third calculation formula saved in the standard table 232S, in the cell of the spreadsheet 100 in which the first calculation formula displayed on the display device 26 is accepted. Thus, since the calculation result, too, is displayed by mathematical natural display, the calculation result is easily understandable for the user.

Note that in the spreadsheet system 1 of the embodiment, the terminal 20, which converted the second calculation formula to the third calculation formula, transmits the third calculation formula via the network 30 to the calculation server 10 that is the calculation processing unit that calculates the third calculation formula, and receives the calculation result of the calculation server 10. In this manner, in the spreadsheet system 1 of the embodiment, the terminal 20 and the calculation server 10 cooperate to execute calculation.

Here, in the case where the first calculation formula incudes a spreadsheet software function, such as COUNT function or OFFSET function, which cannot be converted to the format that can be calculated by the calculation server 10, the terminal 20 executes calculation by this spreadsheet software function in regard to the numerical value data in the calculation result calculated by the calculation server 10. Thus, even if there is a spreadsheet software function that cannot be calculated by the calculation server 10, the spreadsheet system 1 can acquire the calculation result.

Additionally, according to the spreadsheet system 1 (spreadsheet apparatus) of the embodiment, the terminal 20 determines whether each calculation element (a numerical value, a calculation formula, etc.) included in the accepted first calculation formula is the first part corresponding to the cell coordinate that refers to the cell of the table, or the second part corresponding to the LaTex notation method. In accordance with the determination result, the terminal 20 converts the first calculation formula to the second calculation formula of the second format that can be calculated by a predetermined calculation processing unit, for example, the calculation server 10 that is communicable via the network 30. Accordingly, the spreadsheet system 1 can execute calculation by accepting, as the calculation formula described by the LaTex notation method, the calculation formula in the case of executing calculation with a target being the calculation element included in the first calculation formula. Therefore, the user can input the calculation formula by a more flexible description format.

The methods of the processes by the spreadsheet system 1 described in the above embodiment, that is, the methods such as the spreadsheet process illustrated in the flowchart of FIG. 7 and the spreadsheet software function conversion process illustrated in the flowchart of FIG. 8, can be distributed by being stored, as a computer-executable program of the spreadsheet software 241, in a non-transitory recording medium of an external recording device, such as a memory card (ROM card, RAM card, or the like), a magnetic disk (floppy (trademark) disk, hard disk, or the like), an optical disc (CD-ROM, DVD, or the like), or a semiconductor memory. In addition, a control unit such as a processor (CPU) of an information processing apparatus (electronic equipment) reads the program recorded in the non-transitory recording medium of the external recording apparatus into a storage device, and causes the operation to be controlled by the read program, thereby being able to implement the various functions described in the embodiments, and to execute processes similar to the processes by the above-described methods.

Additionally, the data of the program for implementing each method can be transmitted over the network 30 as a mode of program code. The data of the program can be taken into the terminal 20 from a computer apparatus (program server) connected to the network 30, and can be stored in the storage 24, and the above-described various functions can be implemented.

Additionally, in one embodiment, the terminal 20 and the calculation server 10 are configured to cooperate to execute calculation. However, the calculation of the second calculation formula may also be executed in the terminal 20. Specifically, the spreadsheet apparatus may be constituted by the terminal 20 alone.

The present invention is not limited to the above-described embodiments. In practice, various modifications may be made without departing from the spirit of the invention. In addition, the embodiments may be implemented by being combined as appropriate, and advantageous effects of the combined embodiments can be obtained. Furthermore, the embodiments include various, and various inventions can be derived from combinations selected from the structural elements disclosed herein. For example, even if some structural elements in all the structural elements disclosed in the embodiments are omitted, if the problem can be solved and the advantageous effects can be obtained, the structure, in which the structural elements are omitted, can be derived as an invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A spreadsheet apparatus comprising a processor, the processor being configured to:
accept a calculation formula for executing calculation with a target being a calculation element that is input in a table format, as a first calculation formula of a first format including a first part corresponding to a description format of referring to a cell of a table and a second part corresponding to a description format for mathematical natural display; and
execute one of (i) a calculation process for calculating the first calculation formula by using a value of the cell that the first part refers to, and (ii) a display process for displaying on a display the first calculation formula in a display mode of the mathematical natural display indicated by the second part.

2. The spreadsheet apparatus of claim 1, wherein the processor is configured to:
determine whether each of the calculation elements included in the first calculation formula is the first part or the second part; and
convert the first calculation formula of the first format to a second calculation formula of a second format that does not refer to the cell of the table, by taking in a value of the cell which the first part refers to.

3. The spreadsheet apparatus of claim 2, further comprising a calculation processing unit capable of calculating a calculation formula of a third format that includes neither the first part nor the second part, wherein
the processor is configured to:
be capable of causing the calculation processing unit to execute calculation of a designated calculation formula;
convert the second calculation formula of the second format to a third calculation formula of the third format; and
cause the calculation processing unit to calculate the third calculation formula of the third format as the calculation process.

4. The spreadsheet apparatus of claim 1, wherein
the first calculation formula is a calculation formula that is input to a cell of the table, and
the processor is configured to:
determine whether to execute the calculation process for the first calculation formula or to execute the display process for the first calculation formula, in accordance with a description format of the first calculation formula in the cell.

5. The spreadsheet apparatus of claim 1, wherein
the first part includes a description of a function for spreadsheet calculation for executing calculation that refers to the cell of the table, and a description of a cell coordinate for designating the cell of the table to be referred to, and
the second part includes a description of a function for the mathematical natural display that does not refer to the cell of the table, and a description of a parameter that is not a cell coordinate and is a calculation target of the function for the mathematical natural display.

6. The spreadsheet apparatus of claim 3, wherein
the first calculation formula is a calculation formula that is input to the cell of the table, and
the processor is configured to:
accept an input of the first part included in the first calculation formula, as text of an input character as such, and
accept an input of the second part included in the first calculation formula, as text by a notation method for a typesetting process system.

7. The spreadsheet apparatus of claim 6, wherein the notation method for the typesetting process system is a LaTex notation method.

8. The spreadsheet apparatus of claim 7, wherein the processor accepts, as the calculation element that is input in the table format,
numerical value data that is a numerical value or a variable, and
LaTex data in which a numerical value is expressed by the LaTex notation method.

9. The spreadsheet apparatus of claim 8, wherein the processor is configured to cause the cell to display the LaTex data that is input to the cell, by the mathematical natural display.

10. The spreadsheet apparatus of claim 8, wherein the processor is configured to save, as the cell value of the cell of the table,
the input LaTex data, and
numerical value data in which the input LaTex data is converted to a numerical value.

11. The spreadsheet apparatus of claim 10, wherein
the first part included in the first calculation formula includes a spreadsheet function, and
the conversion of the first calculation formula to the second calculation formula includes replacing, based on a content of the spreadsheet function, an input content with LaTex data by the LaTex notation method, and includes replacing, by using the LaTex data saved in the cell that is referred to, the first calculation formula of the first format with the second calculation formula of the LaTex notation method that is the second format that can be calculated.

12. The spreadsheet apparatus of claim 10, wherein the processor is configured to save, as a cell value for the cell in which the first calculation formula is accepted, a calculation result of the third calculation formula by the LaTex data and the numerical value data.

13. The spreadsheet apparatus of claim 12, wherein the processor is configured to cause the cell in which the first calculation formula is accepted, to display, by the mathematical natural display, the LaTex data that is the calculation result of the third calculation formula.

14. The spreadsheet apparatus of claim 3, wherein the calculation processing unit includes a calculation server that is communicable via a network.

15. The spreadsheet apparatus of claim 14, wherein
the first part included in the first calculation formula includes a spreadsheet function, and
the processor is configured to execute, in a case where the first calculation formula includes a spreadsheet function that cannot be processed by the calculation server, calculation by the spreadsheet function in regard to numerical value data in a calculation result calculated by the calculation server.

16. The spreadsheet apparatus of claim 1, wherein the processor is configured to:
determine whether each calculation element included in the accepted first calculation formula is the first part corresponding to the cell coordinate that refers to the cell of the table, or the second part corresponding to the LaTex notation method; and
convert, in accordance with a result of the determination, the first calculation formula to the second calculation formula of the second format that can be calculated by a predetermined calculation processing unit.

17. A spreadsheet method comprising:
by a spreadsheet apparatus, accepting a calculation formula for executing calculation with a target being a calculation element that is input in a table format, as a first calculation formula of a first format including a first part corresponding to a description format of referring to a cell of a table and a second part corresponding to a description format for mathematical natural display; and
by the spreadsheet apparatus, executing one of (i) a calculation process for calculating the first calculation formula by using a value of the cell that the first part refers to, and (ii) a display process for displaying on a display the first calculation formula in a display mode of the mathematical natural display indicated by the second part.

18. A non-transitory computer readable recording medium storing a spreadsheet program for causing a processor included in a spreadsheet apparatus, to:
accept a calculation formula for executing calculation with a target being a calculation element that is input in a table format, as a first calculation formula of a first format including a first part corresponding to a description format of referring to a cell of a table and a second part corresponding to a description format for mathematical natural display; and
execute one of (i) either a calculation process for calculating the first calculation formula by using a value of the cell that the first part refers to, and (ii) or a display process for displaying on a display the first calculation formula in a display mode of the mathematical natural display indicated by the second part.
